(19) United States
(12) Patent Application Publication
(10) Pub. No.: US 2024/0419759 A1
(43) Pub. Date: Dec. 19, 2024

(54) MACHINE LEARNING TRANSFORMATION OPERATIONS FOR INTERLEAVED DATA

(71) Applicant: International Business Machines Corporation, Armonk, NY (US)

(72) Inventors: William JONES, Monroe, NY (US); Tyler Vezio RIMALDI, Mahopac, NY (US)

(21) Appl. No.: 18/335,715

(22) Filed: Jun. 15, 2023

(51) Int. Cl. G06F 17/16

(52) U.S. Cl. CPC G06F 17/16

(57) ABSTRACT

Method and apparatus for improved machine learning transformation operations on interleaved data are provided. A first interleaved data tensor having an unrealized set of dimensions is received, and a transformation operation to apply to the first interleaved data tensor is determined. A realized set of dimensions for output of the transformation operation is determined based on the unrealized set of dimensions and the transformation operation. A second interleaved data tensor is generated by applying the transformation operation to the first interleaved data tensor, comprising copying input elements in the first interleaved data tensor to output elements in the second interleaved data tensor based on indices in the realized set of dimensions.

### STATEMENT REGARDING PRIOR DISCLOSURES BY THE INVENTOR OR A JOINT INVENTOR

The following disclosure(s) are submitted under 35 U.S.C. 102 (b) (1) (A): DISCLOSURE: ibm-zdnn-plugin description and information, available at https://pypi.org/project/ibm-zdnn-plugin/, released Feb. 8, 2023.

### BACKGROUND

The present disclosure relates to machine learning, and more specifically, to improved transformation operations on interleaved data.

A variety of machine learning architectures (e.g., neural networks), though different from implementation to implementation, are often largely comprised of a few notable operations, including matrix multiplication, convolution, activation, and element-wise operations. These operations are often performed on large data sets and can be optimized to be performed in parallel in some cases. For example, such parallelization can be achieved by loading the data into one or more vector registers of a fixed size and utilizing hardware that performs Single Instruction on Multiple Data (SIMD) calls or operations to compute multiple elements at a time.

Generally, the number of data elements that can be performed or operated on in parallel is determined based on the size of the register and the size of each data element. For example, twice as many 16-bit data elements can generally be computed in a SIMD instruction when compared to 32-bit data elements. Often, the amount of data elements to compute is not equal to the number of data elements that fit in the vector registers. As a result, the data is often padded with additional values to fill the vector registers and the padded elements are then ignored during or after computation.

However, such parallelization is difficult or impossible to efficiently implement when the data is interleaved (e.g., non-contiguous, where the data elements may have padding and/or be rearranged). Though interleaving is commonly used for computational and memory efficiency, conventional systems generally require the data be de-interleaved prior to common machine learning operations. The output data is often then re-interleaved. These de-interleave and re-interleave operations introduce substantial computational overhead that reduces or eliminates the benefits of interleaved data and parallel operations.

### SUMMARY

According to one embodiment of the present disclosure, a method is provided. The method includes receiving a first interleaved data tensor having an unrealized set of dimensions; determining a transformation operation to apply to the first interleaved data tensor; determining a realized set of dimensions for output of the transformation operation based on the unrealized set of dimensions and the transformation operation; and generating a second interleaved data tensor by applying the transformation operation to the first interleaved data tensor, comprising copying input elements in the first interleaved data tensor to output elements in the second interleaved data tensor based on indices in the realized set of dimensions.

According to one embodiment of the present disclosure, a system is provided. The system includes one or more computer processors, and a memory containing a program which when executed by the one or more computer processors performs an operation. The operation includes receiving a first interleaved data tensor having an unrealized set of dimensions; determining a transformation operation to apply to the first interleaved data tensor; determining a realized set of dimensions for output of the transformation operation based on the unrealized set of dimensions and the transformation operation; and generating a second interleaved data tensor by applying the transformation operation to the first interleaved data tensor, comprising copying input elements in the first interleaved data tensor to output elements in the second interleaved data tensor based on indices in the realized set of dimensions.

According to one embodiment of the present disclosure, a computer program product is provided. The computer program product includes a computer-readable storage medium having computer-readable program code embodied therewith, the computer-readable program code executable by one or more computer processors to perform an operation. The operation includes receiving a first interleaved data tensor having an unrealized set of dimensions; determining a transformation operation to apply to the first interleaved data tensor; determining a realized set of dimensions for output of the transformation operation based on the unrealized set of dimensions and the transformation operation; and generating a second interleaved data tensor by applying the transformation operation to the first interleaved data tensor, comprising copying input elements in the first interleaved data tensor to output elements in the second interleaved data tensor based on indices in the realized set of dimensions.

### BRIEF DESCRIPTION OF THE DRAWINGS

FIG. 1 depicts an example computing environment for the execution of at least some of the computer code involved in some aspects of the present disclosure.

FIG. 2 depicts an example workflow for performing transformations and computations on interleaved data, according to some embodiments of the present disclosure.

FIG. 3 is a flow diagram depicting an example method for performing transformations on interleaved data, according to some embodiments of the present disclosure.

FIG. 4 is a flow diagram depicting an example method for generating realized indices for interleaved data, according to some embodiments of the present disclosure.

FIG. 5 is a flow diagram depicting an example method for generating output data based on realized indices, according to some embodiments of the present disclosure.

FIG. 6 is a flow diagram depicting an example method for transforming interleaved data, according to some embodiments of the present disclosure.

FIG. 7 depicts an example computing device configured to perform various aspects of the present disclosure, according to some embodiments of the present disclosure.

### DETAILED DESCRIPTION

Embodiments of the present disclosure provide techniques and methods to efficiently perform transformation operations directly on interleaved data, without the need for independent de-interleave or re-interleave operations.

In some embodiments, as discussed above, a variety of machine learning operations (e.g., matrix multiplications) can be performed using parallelized accelerator hardware. While the latency of such parallelized instructions is generally less than corresponding CPU instructions (e.g., the parallelized operations are generally faster than equivalent operations on conventional CPU architectures), the time needed to convert and interleave the data to the correct format and layout often exceeds the time saved from the parallelized instructions (though the output of the operation will already be an interleaved tensor, which allows it to be used in a subsequent parallelized instruction without modification). This is problematic, however, if the output of the parallelized instruction is used as input to an operation that is not supported by a subsequent parallelized instruction or operation. That is, if the subsequent instruction or operation is not parallelized, the interleaved output is immediately converted and de-interleaved back to the original data format and layout.

In practice, it is common for multiple transformation operations (such as broadcasting, splitting, concatenating, reshaping, transposing, squeezing, padding, and reversing) to be performed between parallelized computational instructions that modify the content of the data elements themselves (rather than simply modifying the shape or ordering of the elements), such as matrix multiplications, convolutions, and the like. Although there may be hardware support for such transformation operations (e.g., direct wiring or circuitry used to rearrange the data elements), in some embodiments, transformations can be additionally or alternatively be implemented in software. For example, unlike computational operations (where the resulting output is dependent on the value(s) of the input(s)), transformation operations instead rearrange the values from the input(s) to produce the result, without modifying the data elements themselves. That is, as used herein, computational operations may generally correspond to operations where the output is generated or determined based on the specific values of the input data elements. For example, computational operations may include element-wise summation or multiplication (where the output values are determined based on the values in each input), convolution, matrix multiplication, activation operations, and the like. In contrast, as used herein, transformation operations may generally correspond to operations where the output is generated by reshaping the input, but the actual output values are simply copies of the input values (e.g., the elements can be rearranged without evaluating the actual values in each element).

In some embodiments of the present disclosure, such transformation operations can be implemented by interpreting interleaved data as another format (e.g., a 16-bit data type) and the transformation operations can be implemented using a series of memory copies that take account for the interleaving and padded data. This eliminates the need to convert and de-interleave the data before performing the transformation operations, and ensures that the output remains interleaved such that it can be used in a subsequent parallelized computational instruction.

In some embodiments, the particular operations to enable or perform such efficient transformations can be determined based at least in part of the underlying architecture of the hardware accelerator (e.g., of the parallelized computation hardware). As one example, the IBM™ 216™ platform uses accelerator hardware that can perform select computational instructions on multiple data elements in parallel. Though the z16™ system is used in some aspects as an example accelerator hardware that can be used in conjunction with embodiments of the present disclosure, the techniques described herein are readily applicable to a wide variety of accelerator (e.g., parallelized) architectures. In some embodiments, to utilize this accelerator hardware, a set of Neural Network Process Assistant (NNPA) instructions (also referred to in some aspects as parallelized instructions or operations) are provided, with some data formatting and layout conditions. For example, in some embodiments, the parallelized instructions operate with a DLFloat data type, which is a 16-bit floating-point format with one sign bit, six bits for the exponent, and nine bits for the mantissa. In some embodiments, tensors are converted to the DLFloat format before they can be processed using parallelized computational instructions, and the output of such instructions is also in DLFloat format.

Further, in some embodiments, the parallelized computation instructions operate on four-dimensional tensors (e.g., tensors with 4 dimensions). In some embodiments, non-interleaved tensors (e.g., generic tensors) described herein are generally in row-major. That is, non-interleaved tensors may have a data layout where the elements are enumerated in increasing memory-address order, with the inner dimension (referred to as C in some aspects) incremented first through all C-index-size values (starting with 0 through the C-1), before the index of the W dimension is increased (and the stepping through the C dimension is repeated). The index of the outer dimensions (referred to in some aspects as H and N dimensions) are increased last. In some embodiments, tensors that have lower number of dimensions (e.g. three-dimensional, two-dimensional, and/or one-dimensional tensors) can be represented as four-dimensional tensors with the outer dimensions of the (e.g., any that exceed the original tensor dimensionality) set to a size of one.

In some embodiments, unlike computational operations (which compute the output(s) given the value of the input(s)), transformation operations can be implemented by copying the original value from the input to a different index in the output, where the output index can be determined based on which transformation is being applied.

For example, in some embodiments, the system can deterministically calculate or determine the size of each dimension of an input interleaved tensor by realizing or converting the dimensionality of the input. As one example, if the input tensor has an unrealized dimensionality of [N, H, W, C], the resulting interleaved tensor can be represented as a four-dimensional tensor of vectors, or as a five-dimensional tensor with realized dimensionality

$$[ N , ⌈ \frac{C}{l} ⌉ , H , ⌈ \frac{W}{g} ⌉ * g , l ] ,$$

where N, H, W, and C are integer values of the unrealized dimensionality, ┌⋅┐ is a ceiling operation, and l and g are parameters determined based on the configuration of a hardware accelerator used to process the first interleaved data tensor. In some embodiments, g is the number of tensors that the hardware accelerator processes per clock cycle, and l is a size of each of the tensors (e.g., the number of data elements in each) that the hardware accelerator processes per clock cycle. For example, in some aspects, g is 32 and l is 64 (e.g., where the hardware is configured to process a group of 32 vectors in parallel, each vector having 64 elements).

In some embodiments, the system can deterministically find the index of an element in an input interleaved tensor given the realized dimensions. For example, the element at unrealized index [n, h, w, c] may be found at unrealized index

$$[ n , \frac{c}{l} , h , w , c \% l ] ,$$

where n, c, h, and w are the index in the unrealized set of dimensions and % is a modulo operation.

In some aspects, as the size of the realized dimensions may be larger than the size of the unrealized dimensions, the additional elements in the realized dimensions may be pad elements (e.g., added elements with an irrelevant value), which can be ignored during transformations and computations. Advantageously, by computing or determining unrealized indices based on the realized dimensionality, the system can automatically ignore pad elements in the unrealized indices. That is, because the realized index for a given element is determined based on the unrealized index of the element, the additional or added pad elements in the unrealized index may be readily ignored (and virtually un-indexable).

In some embodiments, to enable efficient tensor transformation (e.g., broadcasting), the system can determine or compute the indices of the transformed input data. That is, the system may deterministically calculate the result of transforming the input dimensions. For example, given unrealized input indices [N, H, W, C] the transformed/output indices may be defined as [Nₜ, Hₜ, Wₜ, Cₜ], where t is defined based on the desired transformation. In this way, the system can deterministically calculate the size of each dimension of the transformed/output interleaved tensor by realizing the dimensionality of the output. For example, given unrealized output dimensionality [Nₜ, Hₜ, Wₜ, Cₜ], the realized output dimensionality may be defined as

$$[ {N}_{t} , ⌈ \frac{{C}_{t}}{l} ⌉ , {H}_{t} , ⌈ \frac{{W}_{t}}{g} ⌉ * g , l ] .$$

Using this formulation, the system can deterministically find the index of any given element of the transformed/output interleaved tensor based on the realized dimensions. For example, unrealized indices [nₜ, hₜ, Wₜ, Cₜ] may be equivalent to realized indices

$$[ {n}_{t} , \frac{{c}_{t}}{l} , {h}_{t} , {w}_{t} , {c}_{t} \% l ] .$$

In this way, in some embodiments, to perform efficient tensor transformations (such as broadcasting), the system can copy the data from the determined input indices to the determined output indices according to

$$[ {n}_{t} , \frac{{c}_{t}}{l} , {h}_{t} , {w}_{t} , {c}_{t} \% l ] = [ n , \frac{c}{l} , h , w , c \% l ] .$$

That is, the value of a given output index

$$( at [ {n}_{t} , \frac{{c}_{t}}{l} , {h}_{t} , {w}_{t} , {c}_{t} \% l ] )$$

may be equal to the value at the corresponding realized input index

$$( at [ n , \frac{c}{l} , h , w , c \% l ] ) .$$

In this way, the system can generate the transformed output by, for each realized output index, copying the value from the corresponding realized input index.

In some embodiments, contiguous input indices that result in contiguous output indices can be copied together (e.g., when applying a transformation along an outer dimension, where the inner dimensions are not affected). Further, in some embodiments, any pad elements in the input(s) and output(s) are not affected, as the unrealized input dimensions are used to determine the realized input and output indices.

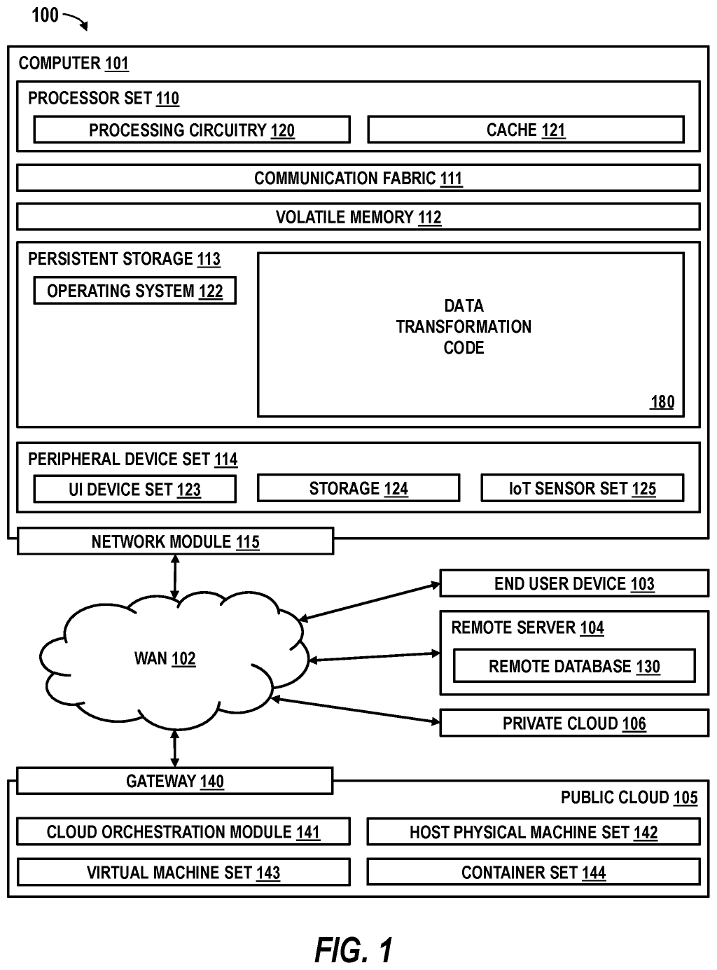

FIG. 1 depicts an example computing environment 100 for the execution of at least some of the computer code involved in some aspects of the present disclosure.

Computing environment 100 contains an example of an environment for the execution of at least some of the computer code involved in performing the inventive methods, such as data transformation code 180. In addition to data transformation code 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data transformation code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in data transformation code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in data transformation code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

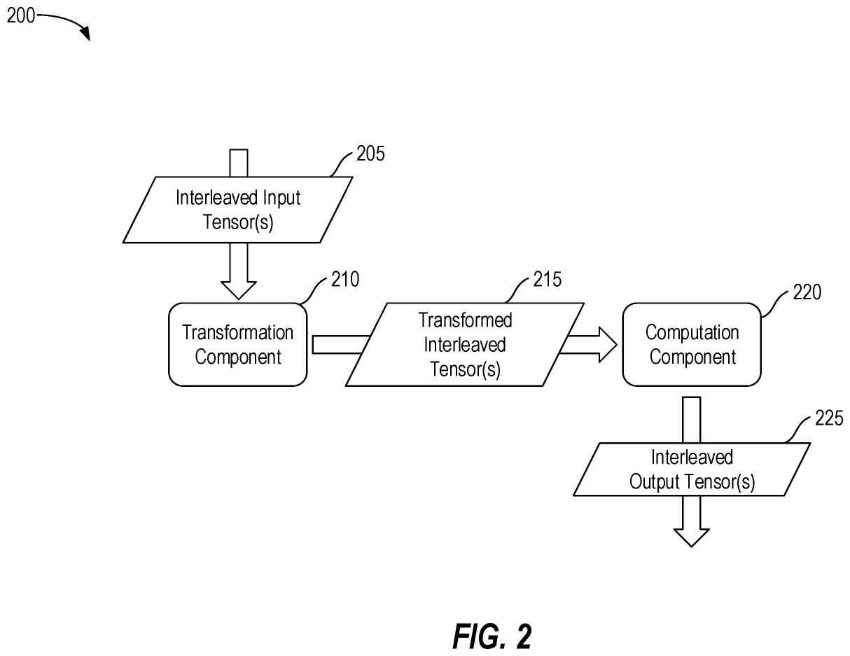

FIG. 2 depicts an example workflow 200 for performing transformations and computations on interleaved data, according to some embodiments of the present disclosure.

In the illustrated example, one or more interleaved input tensors 205 are accessed and processed by a transformation component 210 to generate transformed interleaved tensors 215. As used herein, “accessing” data generally includes receiving, retrieving, requesting, obtaining, or otherwise gaining access to the data. As discussed above, the input tensors may be referred to as “interleaved” to indicate that the elements of an original tensor have been rearranged to facilitate processing (e.g., contiguous or adjacent elements in the original or non-interleaved tensor may not be contiguous or adjacent in the interleaved tensor). For example, as discussed above, input tensors may interleaved to reformat or reshape them according to a preferred or optimized format used by accelerator hardware (e.g., by the computation component 220).

As discussed above, the transformation component 210 can generally be used to perform a variety of transformation operations to interleaved input tensors 205 depending on the particular implementation. As discussed above, transformations generally correspond to operations used to rearrange the data elements of an input tensor without changing the contents or values of the elements. That is, the transformation can be applied by simply reshaping or rearranging the elements without consideration of the actual values in each element. For example, elements in a tensor can be reversed without needing to understand or know the value of the elements themselves.

In some embodiments, tensors are transformed to allow the tensors to be processed using subsequent computations (e.g., by computation component 220). For example, if two tensors are to be added together or otherwise processed using an element-wise computation operation (e.g., using element-wise summation), the tensors must generally have the same shape. In some embodiments, therefore, one or both tensors can undergo various transformations, such as broadcasting, splitting, concatenating, reshaping, transposing, squeezing, padding, and the like. For example, suppose the tensors have different dimensionality ranks, such as if one input tensor has dimensionality [H, W, C] (e.g., it is three-dimensional) and a second input tensor has dimensionality [H, W] (e.g., it is two-dimensional), the lower-dimensionality tensor may be broadcast into the third dimension (e.g., by copying or duplicating one or more values in the lower-dimensionality tensor, such that the broadcasted tensor has dimensionality [H, W, C]). Similarly, if the second tensor has a different shape or size [H, W, C₂], the second tensor may be transformed (e.g., using broadcasting, splitting, squeezing, and the like) to reshape it to [H, W, C].

However, as discussed above, such transformation operations can only be applied to non-interleaved tensors in conventional systems (due to the rearranged shape or ordering of the elements when interleaved). Therefore, in conventional systems, one or more of the interleaved input tensors 205 undergo a de-interleaving operation. The desired transformation(s) are then applied to these de-interleaved tensors, and the tensors are then re-interleaved for processing using the computation component 220. As discussed above, such de-interleaving and re-interleaving operations can consume substantial resources and significantly reduce (or eliminate) the benefits obtained by using hardware accelerators (which operate on interleaved data).

In the illustrated example, the transformation component 210 utilizes realized tensor indices to perform the desired transformation(s) directly on the interleaved input tensors 205, without the need to de-interleave them. For example, the transformation component 210 may be configured to broadcast the interleaved tensor(s) directly. In embodiments, these transformations (when applied to interleaved tensors) take into account the interleaving itself, rather than being implemented as conventional transformations. By using interleaved transformations, the transformation component 210 is able to efficiently perform the transformation operations without de-interleave, thereby substantially reducing the computational expense of the transformations and improving the efficiency and resource-usage of the computations.

As an example, consider two interleaved input tensors: Tensor A having dimensionality [2, 80, 100] and Tensor B having dimensionality [80, 100] (which may be written as [1, 80, 100]). That is, Tensor A may include two groups of eighty vectors, each vector having one hundred elements, and Tensor B may include one group of eighty vectors, each vector having one hundred elements. Suppose further that the desired computation (performed by computation component 220) is addition. To enable this addition, Tensor B may generally be broadcast to the shape of Tensor A (e.g., by duplicating the eighty vectors to form two groups of eighty vectors). However, the interleaved nature of the inputs makes such conventional broadcasting impossible.

In some aspects, therefore, the transformation component 210 instead determines or generates realized indices for the input tensor(s) and applies the desired transformations based on the realized indices, as discussed below in more detail. For example, the transformation component 210 may copy values from the interleaved input tensor(s) 205 to corresponding output indices, where the output indices are determined based on the specific transformation being performed and accounting for the interleaved nature of the input and output tensors.

In some aspects, therefore, the transformation component 210 may interpret the input interleaved input tensors 205 as a predefined data type (e.g., a 16-bit data type) and generate or determine realized dimensionality and indices. For example, in some embodiments, the transformation component 210 deterministically calculates or determines the size of each dimension of an input interleaved tensor by realizing the dimension of the input tensor according to Equation 1 below, where Dimensionality_{R} is the realized dimensionality, the unrealized dimensionality is [N, H, W, C], and g and l are parameters defined based on the configuration of the hardware accelerator (e.g., of the computation component 220). For example, g may correspond to the number of tensors or vectors that the hardware accelerator processes at a time (e.g., per clock cycle), and l is the length or size of each tensor or vector that the hardware processes per clock cycle.

$${Dimensionality}_{R} = [ N , ⌈ \frac{C}{l} ⌉ , H , ⌈ \frac{w}{g} ⌉ * g , l ] \qquad ( 1 )$$

Continuing the above example, the realized dimensions for Tensor A (having unrealized dimensionality [2, 80, 100], which may be rewritten in four dimensions as [1, 2, 80, 100]) may be determined or generated to be [1, 2, 2, 96, 64] if g is thirty-two and l is sixty-four (e.g., if the computation component 220 processes input in the form of thirty-two vectors, each having sixty-four elements, per clock cycle). Note that when realizing the dimensionality of Tensor A, the transformation component 210 does not actually change the dimensionality or shape of the tensor. Instead, the transformation component 210 computes or determines the “realized” dimensionality based on the unrealized tensor dimensions, and uses this realized dimensionality to define the transformation. Additionally, the realized dimensions for Tensor B (having unrealized dimensionality [80, 100], which may be rewritten in four dimensions as [1, 1, 80, 100]) may be determined or generated to be [1, 2, 1, 96, 64] if g is thirty-two and l is sixty-four.

In some aspects, in addition to determining the realized dimensionality, the transformation component 210 can similarly determine realized indices (e.g., indices in the interleaved tensor that correspond to true data elements) based on unrealized indices, such as using Equation 2 below, where index_{R} is an index in the realized set of dimensions corresponding to unrealized index [n, c, h, w] in the interleaved tensor/unrealized set of dimensions, and % is the modulo operation.

$${index}_{R} = [ n , \frac{c}{l} , h , w , c \% l ] \qquad ( 2 )$$

Continuing the above example, for Tensor A, the realized indices containing actual data (from the original Tensor A) may correspond to [:, 0, :, 0: 80, :] (e.g., with respect to the 0^{th} index in the second dimension, the data elements include all elements with respect to the first dimension, all of the elements with respect to the third dimension, the first eighty elements with respect to the fourth dimension, and all of the elements with respect to the fifth dimension) and [:, 1, :, 0: 80, 0: 36] (e.g., with respect to the 1^{st} index in the second dimension, the data elements include all elements with respect to the first dimension, all of the elements with respect to the third dimension, the first eighty elements with respect to the fourth dimension, and the first thirty-six of the elements with respect to the fifth dimension).

Similarly, for Tensor A, the realized indices corresponding to pad elements (e.g., empty elements, null elements, or otherwise elements that are inserted to properly shape the tensor during interleaving) in Tensor A may be the remaining elements (e.g., [:, :, :, 80: 96, :] and [:, 1, 0: 80, 36: 63]).

Additionally, for Tensor B, the realized indices containing actual data (from the original Tensor B) may correspond to [:, 0, :, 0: 80, :] and [:, 1, :, 0: 80, 0: 36], and the realized indices corresponding to pad elements in Tensor B may be the remaining elements (e.g., [: , :, :, 80: 96, :] and [:, 1, 0: 80, 36: 63]).

In an embodiment, the transformation component 210 can thereby perform the desired transformation (e.g., a broadcast operation) based on the transformation itself and the realized dimensions of each input, accounting for padding and interleaving. In some embodiments, the transformation component 210 can similarly determine, calculate, compute, or generate the results of applying the transformations to the input dimensions in a similar manner to the above. For example, suppose a given transformation causes input (unrealized) dimensionality [N, H, W, C] to become dimensionality [Nₜ, Hₜ, Wₜ, Cₜ], where t indicates the specific transformation operation (e.g., broadcasting). That is, the transformation may indicate a mapping of unrealized input dimensionality to unrealized output dimensionality and/or from unrealized input indices to unrealized output indices.

In some embodiments, the transformation component can therefore determine the size of each dimension of the transformed output interleaved tensor by realizing the dimension of the input tensor according to Equation 3 below, where Dimensionality_{OR} is the realized output dimensionality, and the unrealized output dimensionality is [Nₜ, Hₜ, Wₜ, Cₜ].

$${Dimensionality}_{OR} = [ {N}_{T} , ⌈ \frac{{C}_{T}}{l} ⌉ , {H}_{T} , ⌈ \frac{{W}_{T}}{g} ⌉ * g , l ] \qquad ( 3 )$$

The transformation component 210 can similarly determine realized output indices (e.g., indices in the transformed interleaved output tensor that correspond to true data elements) based on the unrealized output indices, such as using Equation 4 below, where index_{OR} is an index in the realized set of output dimensions corresponding to unrealized index at [nₜ, Cₜ, t, wₜ] in the unrealized output dimensions.

$${index}_{OR} = [ {n}_{t} , \frac{{c}_{t}}{l} , {h}_{t} , {w}_{t} , {c}_{t} \% l ] \qquad ( 4 )$$

Therefore, to perform the desired transformation, the transformation component 210 may copy the data from a given index in the realized input indices to the corresponding index in the realized input indices according to Equation 5 below. That is, for each index in the realized input indices, the corresponding data is copied to the index in the realized output indices, as determined using Equation 5 below, at a new memory location (e.g., each element in the input interleaved tensor is copied to a new location in memory or storage determined based on Equation 5).

$$[ {n}_{t} , \frac{{c}_{t}}{l} , {h}_{t} , {w}_{t} , {c}_{t} \% l ] = [ n , \frac{c}{l} , h , w , c \% l ] \qquad ( 5 )$$

In some embodiments during this transformation or copying process, the transformation component 210 may copy continuous or contiguous indices in the input (e.g., sets of adjacent elements that all correspond to data elements, as compared to pad elements) together to improve efficiency of the transformation. Further, in some embodiments, because the realized indices inherently account for padding and interleaving, by using the realized indices, the transformation component 210 bypasses, ignores, or otherwise refrains from processing or copying the pad elements.

In this way, using Equation 5, the transformation component 210 may generate transformed interleaved tensor(s) 215 based on the interleaved input tensor(s) 205. In the depicted workflow 200, the computation component 220 then accesses these transformed interleaved tensors 215 and applies one or more computation operations to generate interleaved output tensors 225. As discussed above, “computation” operations may generally correspond to operations that modify the value of one or more data elements. That is, computation operations may be those where the output is determined based at least in part on the values of one or more data elements in the input (as opposed to transformation operations, where the output can be determined based solely on the structure or shape of the input and the actual data values need not be considered or evaluated). For example, computation operations may include data addition, multiplication, convolution, and the like.

In this way, as discussed above, the workflow 200 enables the interleaved input tensors 205 to be directly transformed using one or more transformation operations without first de-interleaving the data, which can significantly reduce computational expense and latency of performing the transformation(s) and computation(s).

As discussed above, a variety of machine learning architectures (e.g., neural networks) use a large number of computations, such as matrix multiplication, convolution, activation, and element-wise operations using parallelized or accelerator hardware. By using the workflow 200 to perform any intermediate transformations that are used between actual computations (rather than de-interleaving), the functionality and operations of the computer and model can be substantially improved. For example, the computational resources (including memory, storage, energy or power, and the like) consumed during training and inferencing can be substantially reduced. Similarly, using disclosed embodiments, elements such as heat generation, prediction latency, and the like can be reduced. In this way, the disclosed techniques can significantly improve the efficiency and operability of computing devices.

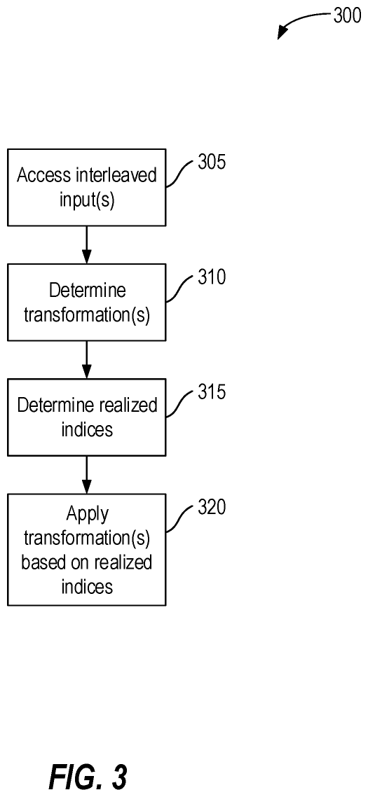

FIG. 3 is a flow diagram depicting an example method 300 for performing transformations on interleaved data, according to some embodiments of the present disclosure. In some aspects, the method 300 can be performed by a transformation component, such as the transformation component 210 of FIG. 2.

At block 305, the transformation component accesses one or more interleaved inputs (e.g., interleaved input tensors 205 of FIG. 2) for processing using one or more transformation operations. At block 310, the transformation component determines the transformation(s) that are to be applied (e.g., based on the configuration of the neural network). For example, one layer (or transformation between layers) may be configured to perform a transformation (e.g., broadcasting) on output from one computation layer (e.g., from one convolution or activation) before a subsequent computation layer (e.g., a subsequent convolution) is applied. Although depicted as a discrete determination for conceptual clarity, in some embodiments, the transformation(s) are determined at a prior time (e.g., during hardware design or model deployment), and the transformation component may simply operate based on this pre-configuration.

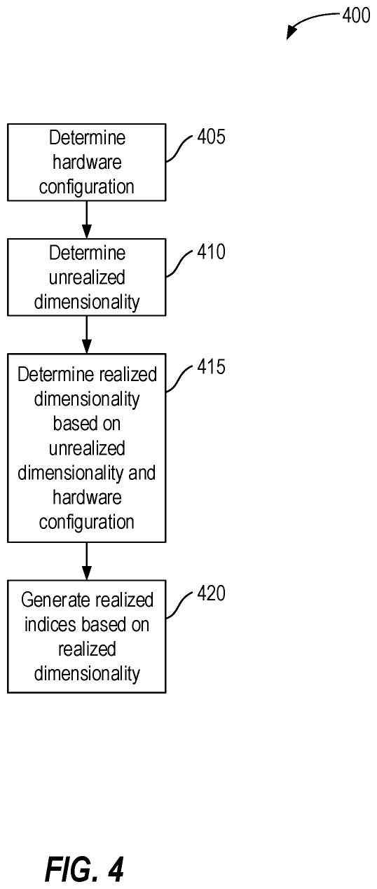

At block 315, the transformation component determines a set of realized indices based on the interleaved input(s) and the determined transformation, as discussed above. For example, using Equations 1, 2, 3, and/or 4, the transformation component may determine the realized input dimensionality, the realized input indices, the realized output dimensionality, and/or realized output indices. One example method for determining the realized indices is discussed in more detail below with reference to FIG. 4.

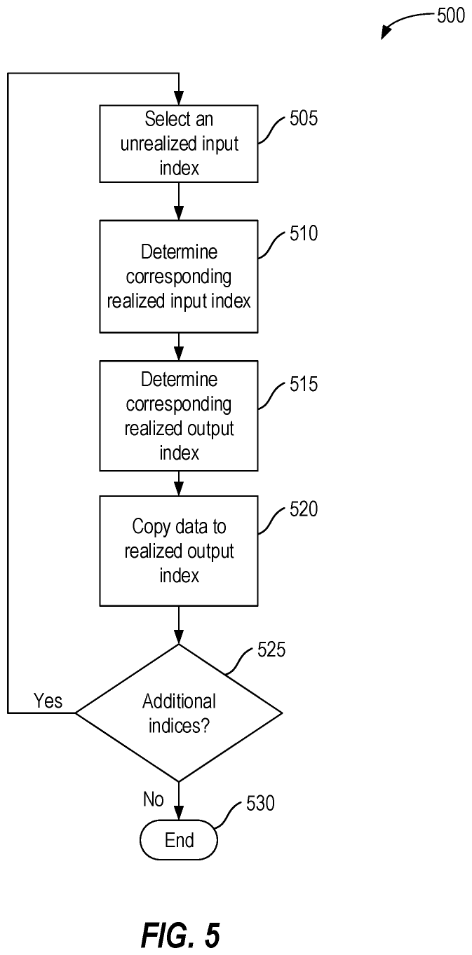

At block 320, the transformation component applies the determined transformation(s) based on the realized indices, as discussed above. In some embodiments, as discussed above, these transformation(s) are applied directly to the interleaved inputs, without first de-interleaving or subsequently re-interleaving. For example, using Equation 5, the transformation component may copy data from the realized input indices to the realized output indices to perform the transformation(s). One example method for applying the transformation(s) is discussed in more detail below with reference to FIG. 5.

As discussed above, the method 300 may thereby be repeated or used whenever transformations on interleaved data are desired or used, such as between convolutions or other computation operations in neural network architectures, to substantially improve the operations (e.g., reduce latency and computational expense) of processing data using the architectures.

FIG. 4 is a flow diagram depicting an example method 400 for generating realized indices for interleaved data, according to some embodiments of the present disclosure. In some aspects, the method 400 can be performed by a transformation component, such as the transformation component 210 of FIG. 2. In some aspects, the method 400 provides additional detail for block 315 of FIG. 3.

At block 405, the transformation component determines the configuration of the accelerator hardware (or other component) that will be used to perform a subsequent computation (e.g., computation component 220 of FIG. 2). For example, the transformation component may determine the number of tensors or vectors that the computation component processes in parallel (e.g., per clock cycle), the length of tensors or vectors that the computation component processes in parallel (e.g., per clock cycle), and the like. Although depicted as a discrete determination for conceptual clarity, in some embodiments, the accelerator configuration information may be determined at a prior time (e.g., during hardware design or model deployment), and the transformation component may simply operate based on this pre-configuration.

At block 410, the transformation component determines the unrealized dimensionality of the input interleaved tensor(s) and/or the unrealized dimensionality of the output interleaved tensor(s). At block 415, the transformation component then determines the realized dimensionality of the input tensor(s) and/or the output tensor(s) based on the unrealized dimensionalities. For example, the transformation component may use Equations 1 and 3 above to determine the realized dimensionalities.

At block 420, the transformation component generates or determines realized indices in the input and/or output realized dimensions based on the realized dimensionality. For example, the transformation component may use Equations 2 and 4 above to determine the realized indices in the inputs and outputs. As discussed above, these realized indices can then be used to efficiently perform the transformation(s) directly on the interleaved tensors, which substantially improves the operations (e.g., reduce latency and computational expense) of processing interleaved data using a variety of machine learning architectures (such as neural networks).

FIG. 5 is a flow diagram depicting an example method 500 for generating output data based on realized indices, according to some embodiments of the present disclosure. In some aspects, the method 500 can be performed by a transformation component, such as the transformation component 210 of FIG. 2. In some aspects, the method 500 provides additional detail for block 320 of FIG. 3.

At block 505, the transformation component selects an index in the unrealized dimensionality/in the set of unrealized input indices. For example, the transformation component may select an unrealized index [n, h, w, c] from unrealized dimensionality [N, H, W, C]. That is, at block 505, the transformation component selects a data element in the interleaved input. Although depicted as a sequential process for conceptual clarity (selecting and evaluating each input data element sequentially), in aspects, some or all of the elements/unrealized indices may be processed partially or entirely in parallel.

At block 510, the transformation component determines the corresponding realized input index for the selected unrealized input index (e.g., based on Equation 2 above). At block 515, the transformation component can then determine the corresponding realized output index for the selected unrealized input index (e.g., based on Equation 4 above) using the realized input index. As discussed above, the realized output index may be defined based at least in part on the specific transformation(s) being applied.

At block 520, the transformation component copies the data found at the selected unrealized input index/the realized input index to the determined realized output index, as discussed above (e.g., using Equation 5). In this way, the transformation component can transform interleaved inputs directly by copying data to realized indices while accounting for padding and the interleaved (e.g., non-contiguous) data structure itself.

At block 525, the transformation component determines whether there is at least one additional index in the unrealized input indices remaining. If so, the method 500 returns to block 505 to select another index. Generally, the index can be selected using any suitable technique, including randomly or pseudo-randomly, as all indices in the unrealized dimensions will be processed during the method 500. Additionally, as discussed above, although depicted as a sequential or iterative process for conceptual clarity, in some aspects, some or all of the elements may be processed in parallel.

If, at block 525, the transformation component determines that no further indices remain, the method 500 terminates at block 530. In this way, as discussed above, the transformation component can efficiently perform the transformation(s) directly on the interleaved tensors, which substantially improves the operations (e.g., reduce latency and computational expense) of processing interleaved data using a variety of machine learning architectures (such as neural networks).

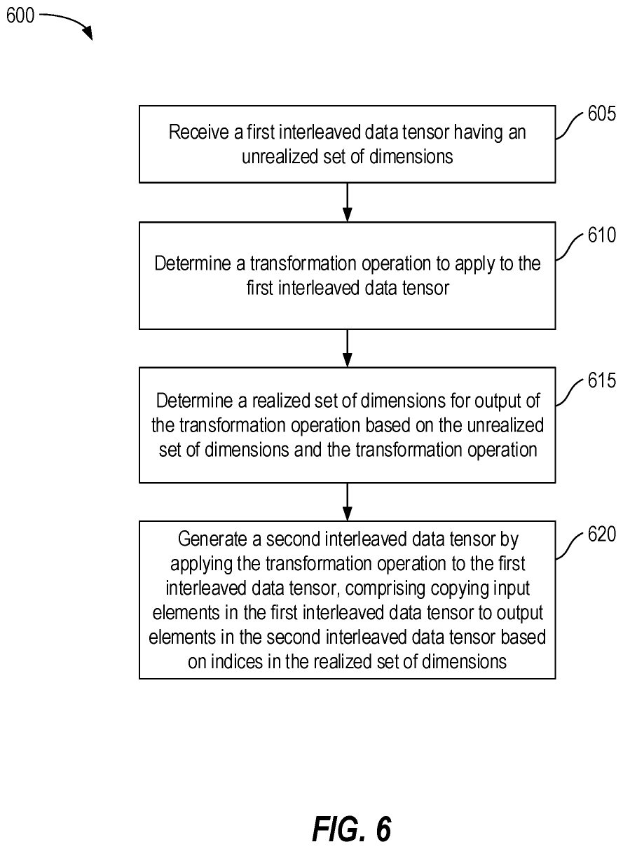

FIG. 6 is a flow diagram depicting an example method 600 for transforming interleaved data, according to some embodiments of the present disclosure. In some aspects, the method 600 is performed by a transformation component, such as transformation component 210 of FIG. 2.

At block 605, a first interleaved data tensor (e.g., interleaved input tensor 205 of FIG. 2) having an unrealized set of dimensions is received.

At block 610, a transformation operation to apply to the first interleaved data tensor is determined (e.g., as discussed above with reference to block 310 of FIG. 3).

At block 615, a realized set of dimensions for output of the transformation operation is determined based on the unrealized set of dimensions and the transformation operation (e.g., using Equations 1, 2, 3, and/or 4 above).

At block 620, a second interleaved data tensor (e.g., interleaved output tensor 225 of FIG. 2) is generated by applying the transformation operation to the first interleaved data tensor, comprising copying input elements in the first interleaved data tensor to output elements in the second interleaved data tensor based on indices in the realized set of dimensions (e.g., using Equation 5 above).

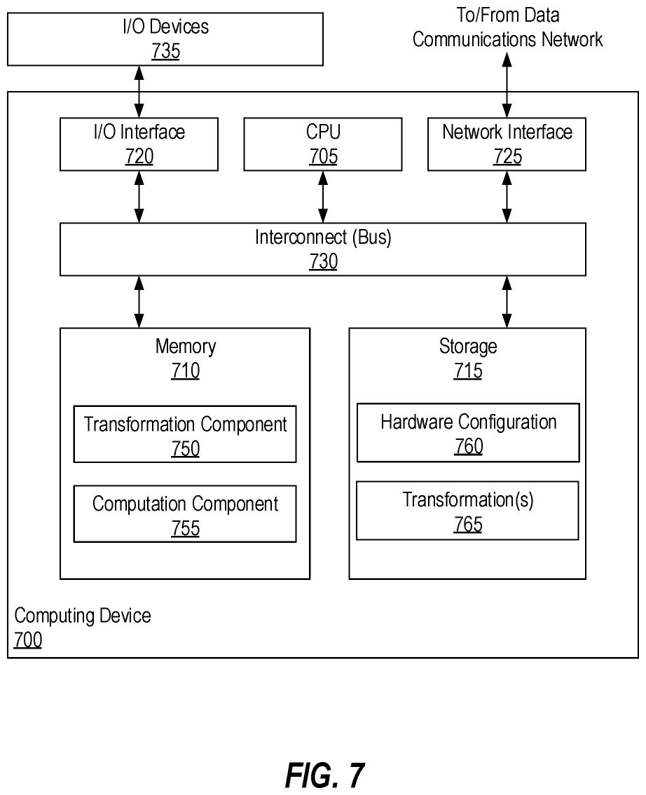

FIG. 7 depicts an example computing device 700 configured to perform various aspects of the present disclosure, according to some embodiments of the present disclosure. Although depicted as a physical device, in embodiments, the computing device 700 may be implemented using virtual device(s), and/or across a number of devices (e.g., in a cloud environment). In one embodiment, the computing device 700 corresponds to the data transformation code 180 of FIG. 1.

As illustrated, the computing device 700 includes a CPU 705, memory 710, storage 715, a network interface 725, and one or more I/O interfaces 720. In the illustrated embodiment, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally included to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

In the illustrated embodiment, the memory 710 includes a transformation component 750 (which may correspond to the transformation component 210 of FIG. 2) and a computation component 755 (which may correspond to the computation component 220 of FIG. 2), which may perform one or more embodiments discussed above. Although depicted as discrete components for conceptual clarity, in embodiments, the operations of the depicted components (and others not illustrated) may be combined or distributed across any number of components. Further, although depicted as software residing in memory 710, in embodiments, the operations of the depicted components (and others not illustrated) may be implemented using hardware, software, or a combination of hardware and software.

In one embodiment, the transformation component 750 may be used to generate, compute, or determine realized dimensionality and indices based on unrealized inputs and/or outputs, and/or based on the transformation(s) to be applied, as discussed above. For example, the transformation component 750 may, for each type of transformation 765, determine a corresponding unrealized output index for each unrealized input index. Based on the hardware configuration 760, the transformation component may then determine realized dimensionality and indices for the inputs and outputs. In some aspects, the transformation component 750 may then use the realized indices to perform the transformation directly on the interleaved data, as discussed above.

In some embodiments, the computation component 755 may be used to apply computation operations to interleaved data, as discussed above. For example, the computation component 755 may receive or access interleaved tensors as input (e.g., generated by the transformation component 750), and generate output interleaved tensors using one or more computation operations (such as convolution, multiplication, summation, and the like). These interleaved outputs may then be used as input to a subsequent computation and/or to a subsequent transformation, as discussed above.

In the illustrated example, the storage 715 includes a hardware configuration 760 and information about a set of transformations 765. In some embodiments, the hardware configuration 760 indicates one or more aspects of the accelerator configuration, such as the number of tensors it can process per clock cycle, the size of tensors it can process, and the like, as discussed above. The transformations 765 generally correspond to transformation(s) that the transformation component 750 can apply to interleaved data, such as broadcasting, splitting, and the like. In an embodiment, each transformation 765 indicates the mapping between unrealized input dimensions and unrealized output dimensions and/or a mapping between unrealized input indices and unrealized output indices, as discussed above. Although depicted as residing in storage 715, the hardware configuration 760 and transformations 765 may be stored in any suitable location, including memory 710.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

While the foregoing is directed to embodiments of the present invention, other and further embodiments of the invention may be devised without departing from the basic scope thereof, and the scope thereof is determined by the claims that follow.

What is claimed is:

1. A method, comprising:
receiving a first interleaved data tensor having an unrealized set of dimensions;
determining a transformation operation to apply to the first interleaved data tensor;
determining a realized set of dimensions for output of the transformation operation based on the unrealized set of dimensions and the transformation operation; and
generating a second interleaved data tensor by applying the transformation operation to the first interleaved data tensor, comprising copying input elements in the first interleaved data tensor to output elements in the second interleaved data tensor based on indices in the realized set of dimensions.

2. The method of claim 1, wherein determining the realized set of dimensions comprises deterministically calculating a size of each dimension in the realized set of dimensions based on a size of each dimension in the unrealized set of dimensions.

3. The method of claim 2, wherein the unrealized set of dimensions comprises four dimensions having sizes [N, H, W, C] and the realized set of dimensions comprises five dimensions having sizes
$$[ N , ⌈ \frac{C}{l} ⌉ , H , ⌈ \frac{w}{g} ⌉ * g , l ] ,$$
wherein:
N, H, W, and C are integers,
┌⋅┐ is a ceiling operation, and
l and g are parameters determined based on a configuration of a hardware accelerator used to process the first interleaved data tensor.

4. The method of claim 3, wherein:
g is a number of tensors that the hardware accelerator processes per clock cycle, and
l is a size of each of the tensors that the hardware accelerator processes per clock cycle.

5. The method of claim 1, wherein generating the second interleaved data tensor comprises, for each index in the unrealized set of dimensions, determining a corresponding index in the realized set of dimensions.

6. The method of claim 5, wherein determining the corresponding index in the realized set of dimensions is performed according to
$${index}_{R} = [ n , \frac{c}{l} , h , w , c \% l ] ,$$
wherein:
index_{R} is the corresponding index in the realized set of dimensions,
n, c, h, and w are the index in the unrealized set of dimensions,
% is a modulo operation, and
l is a parameter determined based on a configuration of a hardware accelerator used to process the first interleaved data tensor.

7. The method of claim 1, wherein:
a rank of the realized set of dimensions is larger than a rank of the unrealized set of dimensions,
the realized set of dimensions includes one or more additional elements not included in the unrealized set of dimensions, and
the one or more additional elements in the realized set of dimensions comprise pad elements that are ignored during application of the transformation operation.

8. The method of claim 1, wherein copying the input elements in the first interleaved data tensor to output elements in the second interleaved data tensor comprises copying contiguous indices in the realized set of dimensions together.

9. A system, comprising:
one or more computer processors; and
a memory containing a program which when executed by the one or more computer processors performs an operation, the operation comprising:
receiving a first interleaved data tensor having an unrealized set of dimensions;
determining a transformation operation to apply to the first interleaved data tensor;
determining a realized set of dimensions for output of the transformation operation based on the unrealized set of dimensions and the transformation operation; and
generating a second interleaved data tensor by applying the transformation operation to the first interleaved data tensor, comprising copying input elements in the first interleaved data tensor to output elements in the second interleaved data tensor based on indices in the realized set of dimensions.

10. The system of claim 9, wherein determining the realized set of dimensions comprises deterministically calculating a size of each dimension in the realized set of dimensions based on a size of each dimension in the unrealized set of dimensions.

11. The system of claim 10, wherein the unrealized set of dimensions comprises four dimensions having sizes [N, H, W, C] and the realized set of dimensions comprises five dimensions having sizes
$$[ N , ⌈ \frac{C}{l} ⌉ , H , ⌈ \frac{w}{g} ⌉ * g , l ] ,$$
wherein:
N, H, W, and C are integers,
┌⋅┐ is a ceiling operation, and
l and g are parameters determined based on a configuration of a hardware accelerator used to process the first interleaved data tensor.

12. The system of claim 11, wherein:
g is a number of tensors that the hardware accelerator processes per clock cycle, and
l is a size of each of the tensors that the hardware accelerator processes per clock cycle.

13. The system of claim 9, wherein generating the second interleaved data tensor comprises, for each index in the unrealized set of dimensions, determining a corresponding index in the realized set of dimensions.

14. The system of claim 13, wherein determining the corresponding index in the realized set of dimensions is performed according to
$${index}_{R} = [ n , \frac{c}{l} , h , w , c \% l ] ,$$
wherein:
index_{R} is the corresponding index in the realized set of dimensions,
n, c, h, and w are the index in the unrealized set of dimensions,
% is a modulo operation, and
l is a parameter determined based on a configuration of a hardware accelerator used to process the first interleaved data tensor.

15. A computer program product comprising a computer-readable storage medium having computer-readable program code embodied therewith, the computer-readable program code executable by one or more computer processors to perform an operation comprising:
receiving a first interleaved data tensor having an unrealized set of dimensions;
determining a transformation operation to apply to the first interleaved data tensor;
determining a realized set of dimensions for output of the transformation operation based on the unrealized set of dimensions and the transformation operation; and
generating a second interleaved data tensor by applying the transformation operation to the first interleaved data tensor, comprising copying input elements in the first interleaved data tensor to output elements in the second interleaved data tensor based on indices in the realized set of dimensions.

16. The computer program product of claim 15, wherein determining the realized set of dimensions comprises deterministically calculating a size of each dimension in the realized set of dimensions based on a size of each dimension in the unrealized set of dimensions.

17. The computer program product of claim 16, wherein the unrealized set of dimensions comprises four dimensions having sizes [N, H, W, C] and the realized set of dimensions comprises five dimensions having sizes
$$[ N , ⌈ \frac{C}{l} ⌉ , H , ⌈ \frac{w}{g} ⌉ * g , l ] ,$$
wherein:
N, H, W, and C are integers,
┌⋅┐ is a ceiling operation, and
l and g are parameters determined based on a configuration of a hardware accelerator used to process the first interleaved data tensor.

18. The computer program product of claim 17, wherein:
g is a number of tensors that the hardware accelerator processes per clock cycle, and
l is a size of each of the tensors that the hardware accelerator processes per clock cycle.

19. The computer program product of claim 15, wherein generating the second interleaved data tensor comprises, for each index in the unrealized set of dimensions, determining a corresponding index in the realized set of dimensions.

20. The computer program product of claim 19, wherein determining the corresponding index in the realized set of dimensions is performed according to index_{R}=[n, c/l, h, w, c % l], wherein:
index_{R} is the corresponding index in the realized set of dimensions,
n, c, h, and w are the index in the unrealized set of dimensions,
% is a modulo operation, and
l is a parameter determined based on a configuration of a hardware accelerator used to process the first interleaved data tensor.
